(19) United States
(12) Patent Application Publication
(10) Pub. No.: US 2020/0305356 A1
(43) Pub. Date: Oct. 1, 2020

(54) Assembly of a Patio Pot and a Plant Pot Support

(71) Applicant: Waterwick B.V., S-Gravendeel (NL)

(72) Inventor: Paul Hansord, Ipswich (GB)

(21) Appl. No.: 16/090,021

(22) PCT Filed: Mar. 29, 2017
(86) PCT No.: PCT/NL2017/050192

§ 371 Date: Sep. 28, 2018

(30) Foreign Application Priority Data
Mar. 31, 2016 (NL) 2016515

(51) Int. Cl. A01G 9/02; A01G 27/06

(52) U.S. Cl. CPC A01G 9/028; A01G 27/02; A01G 27/06

(57) ABSTRACT

Assembly (1) of a patio pot (3), a plant pot support (9) and at least one plant pot (2,4), wherein the plant pot support (9) comprises a through-opening with a wick (6) accommodated in the through-opening of the plant pot support (9) to extend there through towards a fluid reservoir (5) in the patio pot (3).

The present disclosure relates to an assembly, comprising:
a patio pot having a bottom; a fluid reservoir at the bottom of the patio pot; at least one side wall connected to the bottom with a top rim of the patio pot's side wall demarcating an open top of the patio pot.

Patio pots are, in the vocabulary and to the understanding of the skilled person, relatively large pots, for example having a diameter of 20 centimetres or even considerably larger, to be capable of accommodating larger plants and even small trees, and are—in the most pertinent commercially available embodiments—filled from the bottom up with substrate, like gardening soil, plant pot soil, pete, or any other suitable material, possibly with some granulate at the bottom, where the bottom of the pots can be closed or can comprise a water draining hole. When using prior art patio pots, users customarily fill the entire interior of the patio pot with substrate, and then plant plants in the substrate, after having taken the plants from a relatively small plant pot, for example from plastic and having a diameter of normally up to 13 or 15 centimetres, in which the plants are normally acquired. Only in this way the plants are visible above a top rim of a wall of the patio pot after planting in the patio pot. The objective is to have a stem of the plants positioned at a height of a top rim or just below, and show a lush appearance of a fully filled patio pot.

Users remove the container from the plants after acquiring the plant in these plant pot containers, which contributes to amounts of waste generated by these users. Then the roots of the plants taken from the plant pots are planted in the substrate with which the patio pot is entirely filled, this is considered necessary for the plant in the patio pots, after planting therein, to attract water.

This is cumbersome, time consuming, wasteful in relation to the amount of substrate to be used and to the disposal of the containers, and dangerous for the planted plants for a certain time after planting in that a root system thereof is not likely to be able to reach water or other fluid at or near a bottom of the patio pot, since the patio pot is most often much higher than a root system in substrate from the relatively much smaller containers. Nevertheless, users must use large quantities of substrate to fill the patio pot, even if relatively small plants are to be arranged therein,

The present disclosure relates essentially to the added features of:
a plant pot support to be arranged inside the patio pot at a distance from the patio pot's bottom and to carry at least one plant pot, with the plant pot being considerably smaller than the patio pot and having: a bottom; at least one side wall connected to the bottom, with a top edge of the plant pot's side wall demarcating an open top of the plant pot; and
a wick extending from the interior of the plant pot out of the plant pot's bottom to the reservoir,
wherein the plant pot support comprises a through-opening, on which the at least one plant pot is to be arranged with the wick accommodated in the through-opening of the plant pot support to extend there through towards the fluid reservoir.

A patio pot according to the present disclosure therefore allows the containers, in which the plants to be accommodated in the patio pot are acquired and supplied, to be inserted directly in the patio pot and set on the support. In this way, an acquired plant pot can be set on the plant pot support in the patio pot without having to fill the patio pot first with excessive amounts of substrate, and can be added—without having to wastefully and superfluously filling the entire interior of the large patio pot with substrate—into the relatively large patio pot. The containers in which the plant are acquired or otherwise supplied can be used as the plant pots and do not need to be discarded, reducing the amount of waste material. Plants in the plant pots, which are put on the support in the patio pot, can be immediately supplied with water from the fluid reservoir at the bottom of the patio pot, using the wick, as set out herein below, or through any alternative measure, absent the thick layer of substrate between the plants and the fluid reservoir at the bottom of the patio pot.

It is emphasized here that the present disclosure in particular does not relate to inner and outer pots having comparable sizes in terms of especially the top rim of outer pots and the top edge of inner pots and/or heights of inner and outer pots, whereby amounts of substrates for pre-filling the outer pots are modest or absent, or whereby outer pot looks well filled when the inner pot is arranged therein. In contrast the present disclosure relates to assemblies of much larger patio pots for accommodating plants acquired in relatively small plant pots in comparison with the patio pots, where users were obliged to employ wasteful amounts of substrate to sustain plants from small pots in the much larger patio pots.

For example U.S. Pat. No. 1,928,810 relates to combination of essentially equally dimensioned inner and outer pots, moreover missing a wick. Also US-2004/237.403 has essentially equally dimensioned inner and outer pots, and moreover missing a trough-opening to accommodate the wick extending from the plant pot's bottom. Yet further, U.S. Pat. No. 5,722,201 also relates to essentially equally dimensioned inner and outer pots with the inner pot to be arranged on at least one spiral shaped strip in the outer pot at a height to align in height the top edge of the inner pot and the top rim of the outer pot, Because spiral shaped strips should be capable of being stacked with an intermediate plate, without through-openings, effectiveness of any wick under an oblique angle through a side wall of the inner pot is reduced or must be thick and/or wide and/or doubled back on itself, in view of the large distance to bridge from a liquid supply and a root system of the plant in the inner pot. Also, EP-2.255.613 relates to essentially equally dimensioned inner and outer pots, with a stand merely to bridge a height difference between the inner and outer pots, not even to define a fluid reservoir and therefore missing a fluid reservoir and a wick, but having a stand supporting on a bottom of the outer pot. US-2002/152.676 relates to a configuration with plant pot set on top of a net frame with the top edge of inner pots considerably higher than the top rim of the surrounding outer pot, contrary to the intention and purpose of the present invention, and moreover missing any wick from the interior of the plant put through the bottom of the inner pot and extending from the interior of the plant pot. Again, the present applicant's own disclosure in WO-2013/164.300 relates to essentially equally dimensioned inner and outer pots, at least where the size of the top rim of the outer pot and the top edge of the inner pot is concerned. The inner pot is arranged on a dome shaped elevation supporting only a central circle of the bottom of the inner pot, which only works to keep the inner pot straight up if the top edge and the top rim have matching sizes, and moreover, the dome shaped elevation does not exhibit any through-opening to accommodate any wick extending through the bottom.

In an embodiment of the present disclosure, the assembly exhibits the feature that the patio pot further comprising a draining hole to define a top of the fluid reservoir, wherein the plant pot support is arranged in the patio pot at a farther distance from the patio pot's bottom than the draining hole. Although WO-2013/164.300 exhibits a dome shaped elevation with a drain hole, a plant pot on the dome shaped elevation exhibits a dome shaped bottom for stability of supporting the plant pot on the dome shaped elevation of the outer pot. As a consequence an air pocket is defined, hindering full saturation of the substrate in the inner pot, when employing for instance an ebb-and-flood system for watering the plants.

In an additional or alternative embodiment, an assembly according to the disclosure may exhibit a feature that the plant pot support comprises a grid like plate. A grid like plate has openings, through which transfer of fluids like water is facilitated, by accommodating a wick extending through the through-openings defined in the grid like plate and affords the end-user/consumer with a high degree of freedom for placing the plant pot on the support in the patio pot. A net frame as known from US-2002/152.676 is considered to exhibit only very small net opening, insufficient for accommodating a wick having a sufficient water carrying/transporting capacity.

In an additional or alternative embodiment, an assembly according to the present disclosure may exhibit a feature that the support comprises at least one annular ring or rim to positively accommodate at least one bottom of at least one plant pot. As a result, plant pots can be positioned optimally without undue burden for a user, to ensure that plants in the plant pots hide the interior of the patio pot from view as much as possible, at least until the plants in the plant pots mature to develop sufficient foliage to achieve this purpose.

In an additional or alternative embodiment, an assembly according to the present disclosure may exhibit a feature that the plant pot is accommodated in the patio pot at a height, where a top edge of the plant pot at least approximately coincides with a height of the top rim of the patio pot. This results in hiding the plant pots from view as much as possible, behind the top rim of the patio pot, at least until the plants in the plant pots mature to develop sufficient foliage to achieve this purpose.

In an additional or alternative embodiment, an assembly according to the present disclosure may exhibit a feature that an inside of the side wall of the patio pot has a shape diverging from the bottom, and the plant pot support has a circumferential size and shape corresponding with the inside of the side wall of the patio pot at a desired height of the plant pot support in the patio pot to abut the inside of the side wall of the patio pot and be maintained exclusively thereby at the desired height in the patio pot. In this manner the support can be arranged in the patio pot very simply, based on a close fitting relationship between the inside of the patio pot and the circumferential shape of the support.

In an additional or alternative embodiment, an assembly according to the present disclosure may exhibit a further feature of a stand in the patio pot to define or carry the plant pot support. The stand can carry the plant pots, and by providing at least one stand to extend to a desired height inside of the patio pot, the plant pots can extend from the stand to a height of a top rim thereof, to at least approximately coincide with the top rim of the patio pot. More than one stand may be provided, when an patio pot is acquired by an end user.

In an additional or alternative embodiment, an assembly according to the present disclosure may exhibit a feature that the patio pot comprises, on an inside of the patio pot's side wall, at least one shoulder to carry the plant pot support. This can form an alternative or addition both for the close fitting support and/or for the stand, but requires a minor adaptation of the design of the patio pot.

According to the present disclosure, an assembly exhibits the feature that a wick is vertically arranged from the interior of the plant pot and through an plant pot bottom. In such an embodiment the assembly may exhibit the further feature that the wick extends in a direction from a top of the plant pot towards the plant pot's bottom. In such an embodiment the patio pot may exhibit the further feature that the wick is in the interior of the plant pot in fluid contact with the at least one of substrate and plant material.

In an additional or alternative embodiment, an assembly according to the present disclosure may exhibit a feature that the fluid reservoir is defined in the patio pot, to contain at least one of water or other fluid, nutrients, herbicides, pesticides and/or alternative additives. In such an embodiment the patio pot may exhibit the further feature that a fluid level detector is arranged in the fluid reservoir. The fluid level detector may comprise a float arranged in the fluid reservoir. The float may be ring shaped to define a passage with a guide extending through the passage. In an embodiment exhibiting the fluid level detector with a ring shaped float, the assembly may be such that the float is arranged to move up or down with a fluid level in the fluid reservoir, and comprising at least one electrical contact to activate at least one lamp, when the float is in at least one predetermined fluid level. When the ring shaped float is arranged to move up-or-down, and comprises at least one electrical contact, the at least one electrical contact may be arranged in or on the guide. Then the assembly may be such that the guide comprises at least one stop, delimiting movement of the float. The guide may comprise a detection circuit forming the electrical contact, and the float comprises a detectable component, such as a magnet.

In an embodiment having at least the fluid level detector, in whatever shape or form, the assembly may exhibit the further feature that the fluid level detector comprises a lamp, such as an LED light source, configured to be arranged outside of the reservoir and in view.

In an embodiment having at least the fluid level detector, in whatever shape or form, the assembly may exhibit the further feature that the fluid level detector is configured to activate a green colour light when sufficient water is in the fluid reservoir, and a red colour light when insufficient water is in the fluid reservoir.

In an embodiment, the assembly according to the disclosure exhibits the feature that the plant pot support comprises a holder for accommodating a stand, configured for attaching a plant growth guide wire between a free end of the stand and either or both of the plant pot and the patio pot. Then, the stand may be extendible, preferably telescopically extendible. Additionally or alternatively the either or both of the plant pot and the patio pot is or are provided with attachment point at or near an upper side of the side walls of the plant pot and/or the patio pot. Additionally or alternatively, the holder is adjustable in position relative to the plant pot support.

Herein above, embodiments of the present disclosure are referred to on the basis of relatively generic indications of features thereof, corresponding with the definitions in the appended claims. Herein below, more detailed aspects of embodiments of the present disclosure are described referring to the appended drawing. It is emphasized here that the shown embodiments are merely exemplary of the possibilities and functionalities that can be achieved by basic principles of the present disclosure, and that the scope of protection of the present disclosure as defined in the appended claims may encompass alternatives, additions and equivalents of the features and functionalities of the below described embodiments and of the features in the appended claims. Throughout the below embodiment description, the same or similar elements, components, functional units and the like can be referred to using the same or similar reference signs. In the appended drawing:

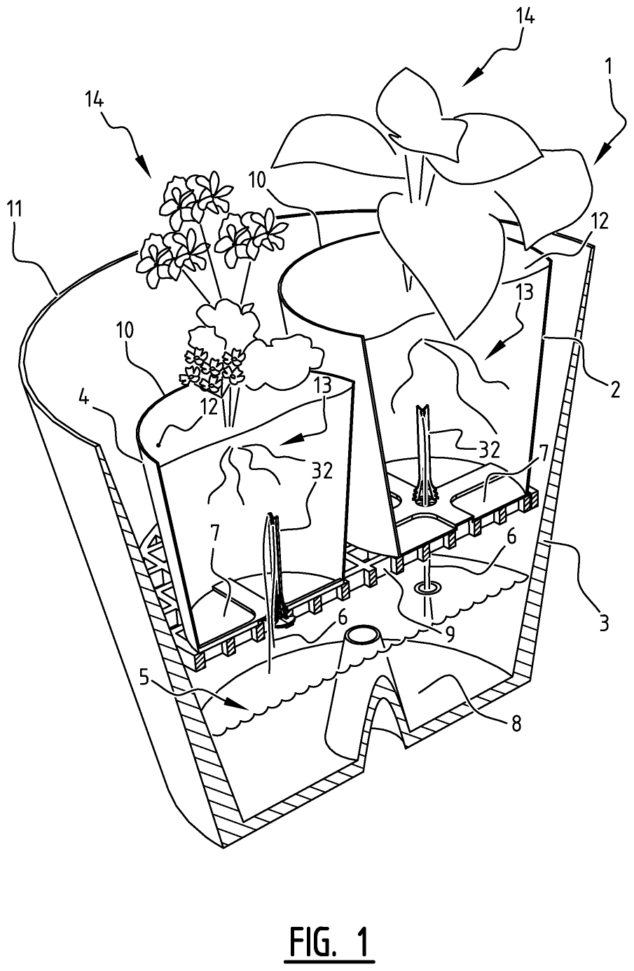

FIG. 1 shows a cross sectional perspective view of an embodiment according to the present disclosure;

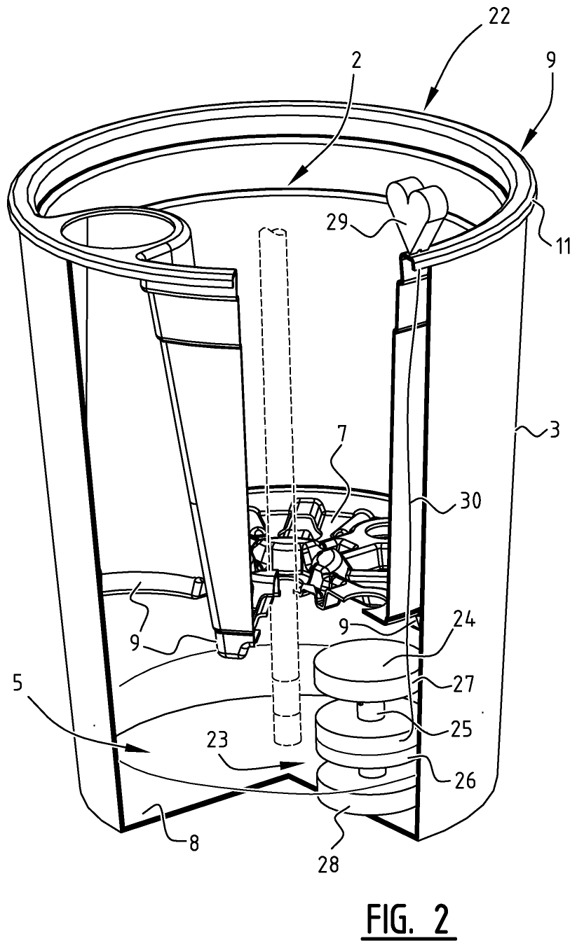

FIG. 2 shows a partially cut away view of an embodiment according to the present disclosure with an added water level indicator;

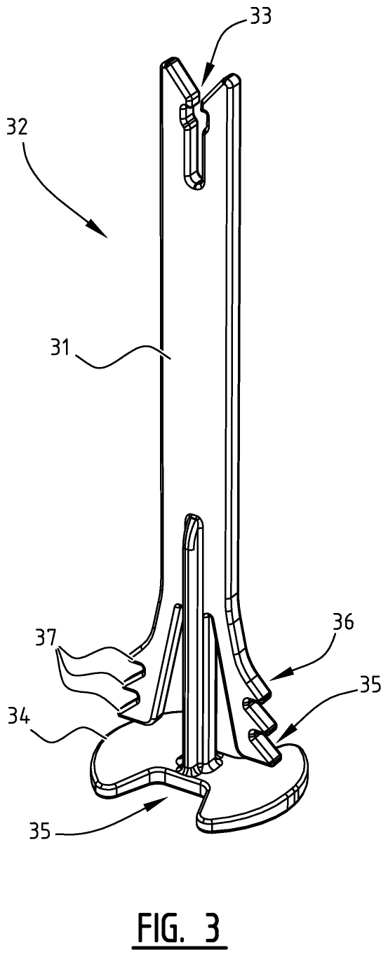

FIG. 3 shows an inserting device for introducing a wick into a plant pot having at least one bottom hole, to extend the wick downward from a plant;

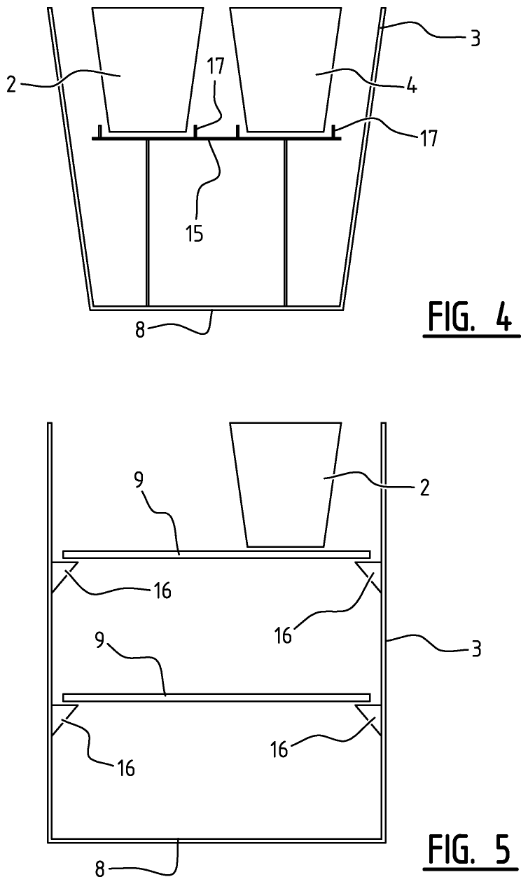

FIG. 4 shows a schematic cross sectional side view of an embodiment including a plant pot support;

FIG. 5 shows a schematic cross sectional side view of an embodiment including shoulders on an inner surface of a side wall of an patio pot for carrying the plant pot support; and

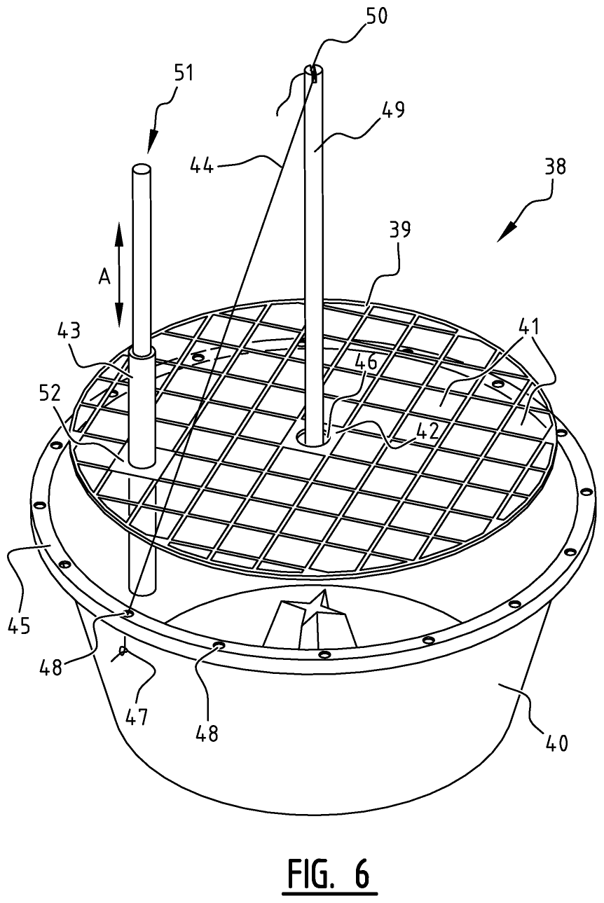

FIG. 6 shows a perspective view of an alternative embodiment with additional features.

The embodiment 1 of an assembly according to the present disclosure in FIG. 1 comprises two plant pots 2, 4 arranged in an patio pot 3. A single plant pot 2 or 4 could be provided, as shown in FIG. 2, or three or more plant pots 2, 4 could also be included in an embodiment of the present disclosure.

In plant pots 2, 4, wicks 6 are arranged to extend from the interior of the plant pots 2, 4 and through bottoms 7 of plant pots 2, 4. A special insertion tool (described in more detail herein below) may be employed to arrange the wicks 6 through at least one of the bottoms 7, and have the wicks 6 extend between the interior, preferably though not exclusively a top of plant pot 2, and out of bottom 8 of patio pot 3, where water reservoir 5 is defined.

A top of the reservoir 5 is defined by a drainage hole 19 in and at the top of dome shaped elevation 18 in a bottom of the patio pot 3. When a water level in the reservoir 5 exceeds the height of the drainage hole 19, water and/or other liquid (possibly containing additives, like plant nutrients, herbicides, pesticides and/or other additives) is drained from the reservoir 5 through the drainage hole 19. Alternatively, water may be inserted into the reservoir 5 from the outside in—for example—an ebb-and-and-flood system. Alternatively, a drainage hole may be provided in a side wall of the patio pot 3 to achieve the same function of draining and/or inserting.

Bottoms 7 of plant pots 2, 4 may have just a single passage to allow only wicks 6 to extend there though, to prevent growing roots from penetrating into reservoir 5 of the patio pot 3.

Plant pots 2, 4 are arranged on a support 9 in patio pot 3. The support 9 is preferably above the top level of the reservoir 5, as defined by the drainage hole 19 in the dome shaped elevation 18. This does not preclude that the dome shaped elevation 18 could have a function to carry the plant pot support 9, as long as water flow in or out through the drainage hole 19 is not hindered. The height of the plant pot support 9 is such that plant pots' top essentially align with a top of the patio pot, to achieve an appearance that plants grow from a patio pot fully filled with substrate (plant stems appear to originate from a fully filled patio pot), even though there's no substrate in the interior of the patio pot 3; only the water reservoir 5 and the plant pot support 9.

Top edges 10 of plant pots 2, 4 are at approximately the same height as top rim 11 of patio pot 3. This makes it look like the stems of plants in plant pots 2 grow from substrate fully filling the patio pot 3, but not present in actuality. In the case of a patio pot 3 with upwardly diverging walls, as depicted in FIG. 1, a diameter of support 9 may be chosen such that this is achieved. The support 9 abuts the inside of the patio pot 3 to be suspended above the liquid reservoir 5. The inside of walls of patio pot 3 may be provided with shoulders 16 at selected heights in the patio pot 3 in FIG. 5 (even with straight vertical walls of the patio pot) or the like, on which the plant pot support 9 may be arranged to accommodate plant pots 2, 4 of different heights, for example to achieve the desired effect that the top edges 10 of plant pots 2, 4 lie at approximately the same height as top rim 10 of patio pot 3. The plant pot support 9 in FIG. 1 is embodied as a grid like plate, allowing passage of wicks 6, to transfer fluids, such as water, from reservoir 5 at the bottom of the patio pot 3 to the plants in the plant pots 2, 4. Additional and/or alternative embodiments are, naturally, also possible. For instance, support 9 may be provided with annular rims 17 in FIG. 4 for accommodating bottoms 7 of plant pots 2, 4, to positively position the plant pots 2, 4 on support 9. A stand 15 in FIG. 4 could be inserted into the patio pot to define or carry the support 9, as an alternative for or in addition to the shoulders 16 or an version of the plant pot support 9 abutting the inside wall of the patio pot 3.

In the plant pots 2, 4, a substrate 12 or a root system 13 of a plant 14, or a combination thereof can be accommodated. In the embodiment of FIG. 1, substrate 12 comprises root system 13 of plants 14.

In the embodiment 23 of FIG. 2, with a single plant pot 2 on support 9 in patio pot 3 but potentially containing more than one plant pot 2, a water level indicator 23 is added. The water level indicator 23 is configured to be employed, even in assemblies of plant pot 2 and patio pot 3, wherein plant pot 2 has a similar diameter as patio pot 3, but is supported on support 9.

The water level indicator 23 comprises a halter- or I shaped holder 24 with a central guide 25 and a ring shaped float 26 arranged on guide 25. When float 26 is raised along guide 25 with an increase in a water level in reservoir 5, the float approximates or eventually abuts a top stop 27 of holder 24. This is detectable, for example using a proximity sensor in float 26 or in top stop 27, which may then generate a switch signal, when a detectable element, such as a magnet, in the other of the float 26 and the top stop 27 has approximated the proximity sensor to a predetermined distance. Likewise, proximity of the float 26 to a lower stop 28 of holder 24 may be detectable, to generate a switch signal, in case of a low water level in reservoir 5, indicating a need to replenish water therein.

In view from outside of the patio pot 3, a lamp 29 in the form of a heart shaped display is connected to the assembly of holder 24 and float 26 via an electrical conductor 30, to turn on at least in case of a low water level in reservoir, to indicate a need to replenish water in reservoir 5 to a user or owner. The conductor 30, which may be a simple electrical cable, can extend along plant pot 2 or also simply anywhere between plant pot 2 and patio pot 3, as in the embodiment of FIG. 2. In the shown embodiment, the conductor 30 is an electrical cable 30 and extends from the float 26, but the detection is more preferably performed from the holder 24 and then the cable more preferably extends from the holder to the lamp 29 or any other element or component to be activated by a controlling switch signal from the water level detector 23.

In an alternative embodiment, the water level indicator 23 may transmit controlling switch signals to a controllable valve to automatically replenish water in reservoir 5, and a series of water level indicators in distinct assemblies of plant pots 2, 4 and patio pots 3 may function to individually regulate water levels in reservoirs 5 of these assemblies, where a valve in a water supply is provided for at least one of the plurality of such assemblies.

An example of an inserting device 32 is shown in FIG. 3. Inserting device 32 comprises an elongate body 31 with a clamp or jaw 33 at one end, and a stop head 34 at an opposing end of the elongate body 31. A wick 6 can be introduced into the clamp or jaw 33 to be engaged therein. The stop head 34 may comprise a similar clamp or jaw to engagingly accommodate wick 6. However, stop head 34 has, in the shown embodiment of FIG. 3, open passages 35 to allow the wick 6 to pass there along unhindered, where clamps (not shown) could be provided in or at passages 35. Consequently, a wick 6 can be accommodated in the clamp or jaws 33.

The stop head 34 preferably has transverse dimensions relative to the lengthwise direction of elongate body 31, which dimensions are sufficiently large to prevent the stop head 34 from being pressed through a hole in a plant pot 2. Consequently, in an assembled state, such a stop head 34 will abut against a bottom or side wall of plant pot 2 after elongate body 31 of inserting device 32 has been inserted through such a hole in such a plant pot 2.

To prevent the inserting device 32 from being retracted out of the plant pot, or falling out of the plant pot, resilient legs 36 are provided on the elongate body 31. These resilient legs 36 are oriented such that these diverge from a connection point with the elongate body 31 towards stop head 34. When the elongate body 31 is pressed through a hole in an inner plant pot 2, 4, resilient or flexible legs 36 will be deflected against the elongate body, as a consequence of which the inserting device 32 and the legs 36 will be able to entirely pass through hole in the plant pot, until the stop head 34 abuts against the plant pot. After having reached such a position, the flexed or flexible legs 36 will revert back to the position that is depicted in FIG. 3, opposite the stop head relative to the surrounding material of the plant pot around the hole through which the inserting device 32 is inserted into the plant pot 2. By appropriate dimensioning of the resilient legs 36, of which at least one should be provided, and of the stop head 34, inserting devices 32 can be employed for up to or more than 90% of all hole diameters in plant pots, irrespective of the plant pot diameters and also practically irrespective of thickness of material layers, from which such plant pots are manufactured, which latter consideration is addressed by appropriate selection of distance between stop head 34 and the free end of resilient or flexible legs 36. Roughening ribs 37 may be provided on legs 36.

With a wick 6 engaged by jaws or clamp 33, such a wick 6 can be automatically inserted into inner plant pots 2, 4 when the inserting device 32 is inserted through the hole in bottoms 7 of the plant pots 2, 4. Inserting the inserting device 32 into the inner plant pots 2, 4 can be accomplished manually or in an automated fashion.

In the embodiment of FIG. 6, a patio pot 38 may have an patio pot grill-like support 39 in an patio pot 40. The plant pot is not shown. The grill-like support 39 has through-openings 41, through which for instance wicks extending from plant pots can be arranged (not shown in FIG. 6). The through holes 41 in the support of the embodiment of FIG. 6 can be filled with a plug or adapter 42 forming a holder for a pole 49. The holder comprises a hole 46 for the pole 49 to be inserted therein. The pole 49 may be extendible telescopically or by linking pole parts. From the top of the pole 49 a plant growth guide wire 44 can be tensioned. For example, tomato plants have considerable benefit from such a guide wire. The top rim 45 of patio pot 40 comprises a number of holes 48 for tensioning the guide wire 44 therethrough. A knot 47 can be made by a user or consumer in the guide wire 44. An opposing end of the guide wire may be drawn into a slit 50 in the upper end of the pole 49. The holes 48 may alternatively or additionally be arranged in the top edge of the plant pot (not shown).

A water level indicator 51 is inserted into a further plug or adapter 52, forming a holder for the water level indicator 51. The water level indicator 51 comprises a tube 43, accommodated in hole 46 of the plug or adapter 52. The tube 43 forms a guide for a float 53, which is thereby free to move up and/or down in the direction of arrow A and inside the tube 43, with a level of water inside the patio pot 40 or inside the plant pot (not shown in FIG. 6).

The present disclosure is by no means limited to the shown embodiments, or mentioned alternatives; the scope of protection is to be determined on the basis of the appended claims, and may even encompass alternatives for features and aspects of the shown and/or described embodiments and also for features defined in the appended claims. It's already noted above, for example, that a water level indicator may be connected to a controllable valve. Likewise, an embodiment may comprise both a valve and a lamp, for instance. The patio pot may be suspended from a cable or wire system to hang from a bracket on a wall or from the ceiling. May other additional or alternative features are also possible within the framework of the present disclosure as defined in the appended claims.

1. Assembly, comprising:
a patio patio pot having:
a bottom;
a fluid reservoir at the bottom of the patio pot;
at least one side wall connected to the bottom, with a top rim of the patio pot's side wall demarcating an open top of the patio pot; and
a plant pot support to be arranged inside the patio pot at a distance from the patio pot's bottom and to carry at least one plant pot, with the plant pot being considerably smaller than the patio pot and having: a bottom; at least one side wall connected to the bottom, with a top edge of the plant pot's side wall demarcating an open top of the plant pot; and a wick extending from the interior of the plant pot out of the plant pot's bottom;
wherein the plant pot support comprises a through-opening, on which the at least one plant pot is to be arranged with the wick accommodated in the through-opening of the plant pot support to extend there through towards the fluid reservoir.

2. Assembly according to claim 1, the patio pot further comprising a draining hole to define a top of the fluid reservoir, wherein the plant pot support is arranged in the patio pot at a farther distance from the patio pot's bottom than the draining hole.

3. Assembly according to claim 1, wherein the plant pot support comprises a grid like plate.

4. Assembly according to claim 1, wherein the plant pot support comprises at least one annular ring or rim to positively accommodate at least one bottom of at least one plant pot.

5. Assembly Patio pot according to claim 1, wherein the plant pot is accommodated in the patio pot at a height, where a top edge of the plant pot at least approximately coincides with a height of the top rim of the patio pot.

6. Assembly according to claim 1, wherein an inside of the side wall of the patio pot has a shape diverging from the bottom, and the plant pot support has a circumferential size and shape corresponding with the inside of the side wall of the patio pot at a desired height of the plant pot support in the patio pot to abut the inside of the side wall of the patio pot and be maintained exclusively thereby at the desired height in the patio pot.

7. Assembly according to claim 1, further comprising a stand in the patio pot to define or carry the plant pot support.

8. Assembly according to claim 1, wherein the patio pot comprises, on an inside of the patio pot's side wall, at least one shoulder to carry the plant pot support.

9. Assembly according to claim 1, wherein the wick extends through an interior of the plant pot in a direction from the top edge towards the plant pot's bottom, or vice versa.

10. Assembly according to claim 9, wherein the wick is in the interior of the plant pot in fluid contact with the at least one of substrate and plant material.

11. Assembly according to claim 1, wherein the fluid reservoir is defined in the patio pot to contain at least one of water or other fluid, nutrients, herbicides, pesticides and/or alternative additives.

12. Assembly according to claim 11, wherein a fluid level detector is arranged in the fluid reservoir.

13. Assembly according to claim 12, wherein the fluid level detector comprises a float arranged in the fluid reservoir.

14. Assembly according to claim 13, wherein the float is ring shaped to define a passage with a guide extending through the passage.

15. Assembly according to claim 13, wherein the float is arranged to move up or down with a fluid level in the fluid reservoir, and comprising at least one electrical contact to activate at least one lamp, when the float is in at least one predetermined fluid level.

16. Assembly according to claim 14, wherein the at least one electrical contact is arranged in or on the guide.

17. Assembly according to claim 14, wherein the guide comprises at least one stop, delimiting movement of the float.

18. Assembly according to claim 14, wherein the guide comprises a detection circuit forming the electrical contact, and the float comprises a detectable component, such as a magnet.

19. Assembly according to claim 12, wherein the fluid level detector comprises a lamp, such as an LED light source, configured to be arranged outside of the reservoir and in view.

20. Assembly according to claim 12, wherein the fluid level detector is configured to activate a green colour light when sufficient water is in the fluid reservoir, and a red colour light when insufficient water is in the fluid reservoir.

21. Assembly according to claim 1, wherein the plant pot support comprises a holder for accommodating a stand, configured for attaching a plant growth guide wire between a free end of the stand and either or both of the plant pot and the patio pot.

22. Assembly according to claim 21, wherein the stand is extendible, preferably telescopically extendible.

23. Assembly according to claim 21, wherein the either or both of the plant pot and the patio pot is or are provided with attachment point at or near an upper side of the side walls of the plant pot and/or the patio pot.

24. Assembly according to claim 21, wherein the holder is adjustable in position relative to the plant pot support.
